(19) United States
(12) Patent Application Publication
(10) Pub. No.: US 2020/0351381 A1
(43) Pub. Date: Nov. 5, 2020

(54) SECURE ARCHITECTURE FOR BROKERAGE AND ORCHESTRATION IN MULTI-TENANT CLOUDS

(71) Applicant: INTERNATIONAL BUSINESS MACHINES CORPORATION, Armonk, NY (US)

(72) Inventors: Derek Lacey, Haslum (NO); Clea Anne Zolotow, Key West, FL (US); Petra Kopp, Toenisvorst (DE); Thomas Brackhahn, Eschborn (DE); Susheel Gooly, Singapore (SG); Pedro Soares, Silveira (PT); Tedrick N. Northway, High Springs, FL (US)

(21) Appl. No.: 16/400,829

(22) Filed: May 1, 2019

(51) Int. Cl. H04L 29/08; G06F 9/455

(52) U.S. Cl. CPC H04L 67/327; G06F 2009/45595; G06F 9/45558

(57) ABSTRACT

At least one shared brokerage service can be hosted on shared hardware. At least a first private brokerage service hosted on first private hardware can be identified. At least a second private brokerage service hosted on second private hardware can be identified. For a first customer, a cloud service broker orchestrates communication of data between the shared brokerage service and the first private brokerage service using application programming interface (API) calls to a first API executing on first private hardware. For a second customer, the cloud service broker orchestrates communication of data between the shared brokerage service and the second private brokerage service using API calls to a second API executing on second private hardware.

### BACKGROUND

The present invention relates to cloud computing, and more specifically, to hosting of brokerage services.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. Both small and large organizations frequently use cloud computing services to host certain types of processes that previously may have been hosted on local computing systems. With the continued proliferation of the Internet, increases in network bandwidth, and increases in computing power, the availability and use of cloud computing continues to increase.

### SUMMARY

A method includes hosting on shared hardware at least one shared brokerage service. The method also can include identifying at least a first private brokerage service hosted on first private hardware. The method also can include identifying at least a second private brokerage service hosted on second private hardware. The method also can include, during execution of a cloud service broker, the cloud service broker orchestrating, using a processor, communication of first data between the shared brokerage service and the first private brokerage service for a first customer, the orchestrating the communication of the first data between the shared brokerage service and the first private brokerage service comprising the cloud service broker accessing the first private brokerage service via application programming interface (API) calls to a first API executing on the first private hardware. The method also can include, during execution of the cloud service broker, the cloud service broker orchestrating communication of second data between the shared brokerage service and the second private brokerage service for a second customer, the orchestrating the communication of the second data between the shared brokerage service and the second private brokerage service comprising the cloud service broker accessing the second private brokerage service via API calls to a second API executing on the second private hardware.

A system includes a processor programmed to initiate executable operations. The executable operations include hosting on shared hardware at least one shared brokerage service. Apr. 22, 2019 The executable operations also can include identifying at least a first private brokerage service hosted on first private hardware. The executable operations also can include identifying at least a second private brokerage service hosted on second private hardware. The executable operations also can include, during execution of a cloud service broker, the cloud service broker orchestrating communication of first data between the shared brokerage service and the first private brokerage service for a first customer, the orchestrating the communication of the first data between the shared brokerage service and the first private brokerage service comprising the cloud service broker accessing the first private brokerage service via application programming interface (API) calls to a first API executing on the first private hardware. The executable operations also can include, during execution of the cloud service broker, the cloud service broker orchestrating communication of second data between the shared brokerage service and the second private brokerage service for a second customer, the orchestrating the communication of the second data between the shared brokerage service and the second private brokerage service comprising the cloud service broker accessing the second private brokerage service via API calls to a second API executing on the second private hardware.

A computer program product includes a computer readable storage medium having program code stored thereon. The program code is executable by a data processing system to initiate operations. The operations include hosting on shared hardware at least one shared brokerage service. The operations also can include identifying at least a first private brokerage service hosted on first private hardware. The operations also can include identifying at least a second private brokerage service hosted on second private hardware. The operations also can include, during execution of a cloud service broker, the cloud service broker orchestrating communication of first data between the shared brokerage service and the first private brokerage service for a first customer, the orchestrating the communication of the first data between the shared brokerage service and the first private brokerage service comprising the cloud service broker accessing the first private brokerage service via application programming interface (API) calls to a first API executing on the first private hardware. The operations also can include, during execution of the cloud service broker, the cloud service broker orchestrating communication of second data between the shared brokerage service and the second private brokerage service for a second customer, the orchestrating the communication of the second data between the shared brokerage service and the second private brokerage service comprising the cloud service broker accessing the second private brokerage service via API calls to a second API executing on the second private hardware.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 depicts a cloud computing environment according to an embodiment of the present invention.

FIG. 2 depicts abstraction model layers according to an embodiment of the present invention.

FIG. 3 is a block diagram illustrating example architecture for a data processing system.

FIG. 4 depicts a cloud service broker that brokers services according to an embodiment of the present invention.

FIG. 5 depicts an implementation of a cloud service broker according to an embodiment of the present invention.

FIG. 6 is a flowchart illustrating an example of a method of orchestrating communication of data between a shared brokerage service and private brokerage services.

### DETAILED DESCRIPTION

The present invention relates to cloud computing, and more specifically, to hosting of brokerage services. In accordance with the inventive arrangements disclosed herein, certain brokerage services (shared brokerage services) can be hosted on shared hardware within a cloud computing environment. Nonetheless, other brokerage services may be hosted in private hardware. For example, organizations may choose to host brokerage services (private brokerage services) that process sensitive data on their own private network, servers, etc. A cloud service broker can be provided to orchestrate communication of data between the shared brokerage services and the private brokerage services without the cloud service broker creating new instances of the private brokerage services on shared hardware. Instead, the cloud service broker can access the private brokerage services via application programming interface (API) calls to APIs executing on the private hardware. This provides a high level of security for the private brokerage services, as well as relieving the shared hardware from actually executing the private brokerage services.

Several definitions that apply throughout this document now will be presented.

As defined herein, the term “cloud service broker” means a component of a cloud computing environment that manages use of brokerage services in the cloud computing environment. As the term “cloud service broker” is defined herein, a cloud service broker is not a person.

As defined herein, the term “brokerage service” means a service provided to at least one customer for use in a cloud computing environment.

As defined herein, the term “shared brokerage service” (also referred to herein as “shared service”) means a brokerage service provided to a plurality of customers for use in a cloud computing environment.

As defined herein, the term “private brokerage service” (also referred to herein as “private service”) means a service provided exclusively to a single customer for use in a cloud computing environment.

As the defined herein, the term “customer” means an entity that utilizes services provided by a cloud computing environment. A customer can be, for example, an organization such as a business or government entity, a person, a group of people, etc.

As defined herein, the term “pattern” means a reusable solution to a commonly occurring scenario within a given computing context that is executed by a processor to implement the solution. A pattern can describe hardware and/or software components to be used for the solution.

As defined herein, the term “container” means is an isolated user space in which computer programs run directly on a host operating system's kernel but have access to a restricted subset of the host operating system's resources. In this regard, a container is a logical packaging mechanism by which applications are decoupled from the computing environment in which the applications execute. Containers allow container-based applications to be deployed easily and consistently, regardless of the target computing environment on which the applications run.

As defined herein, the term “shared hardware” means computer hardware that is shared among a plurality of customers.

As defined herein, the term “private hardware” means computer hardware that is used by, and only by, a single customer.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “data processing system” means one or more hardware systems configured to process data, each hardware system including at least one processor programmed to initiate executable operations and memory.

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “server” means a data processing system configured to share services with one or more other data processing systems.

As defined herein, the term “real time” means a level of processing responsiveness that a user or system senses as sufficiently immediate for a particular process or determination to be made, or that enables the processor to keep up with some external process.

As defined herein, the term “automatically” means without user intervention.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Examples of Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Function as a Service (FaaS): the capability provided to the consumer is to use the provider's cloud infrastructure resources to develop, run and manage application functionalities. The consumer may develop, run and manage application functionalities from various client devices through a thin client interface such as a web browser (e.g., web-based e-mail). The consumer does not manage or control the underlying cloud infrastructure including network, servers, operating systems, storage, with the exception of limited user-specific configurations to implement the development, execution and management of the application functionalities.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

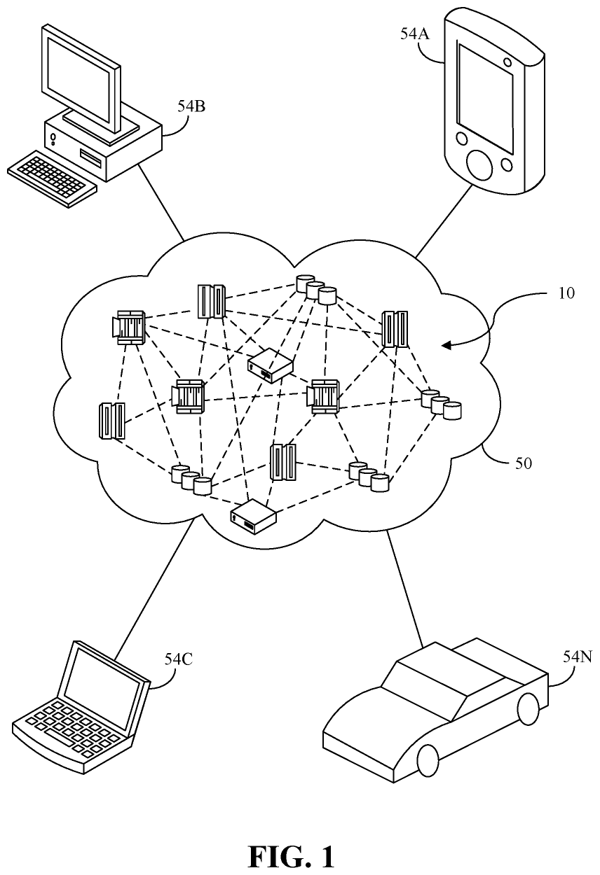

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

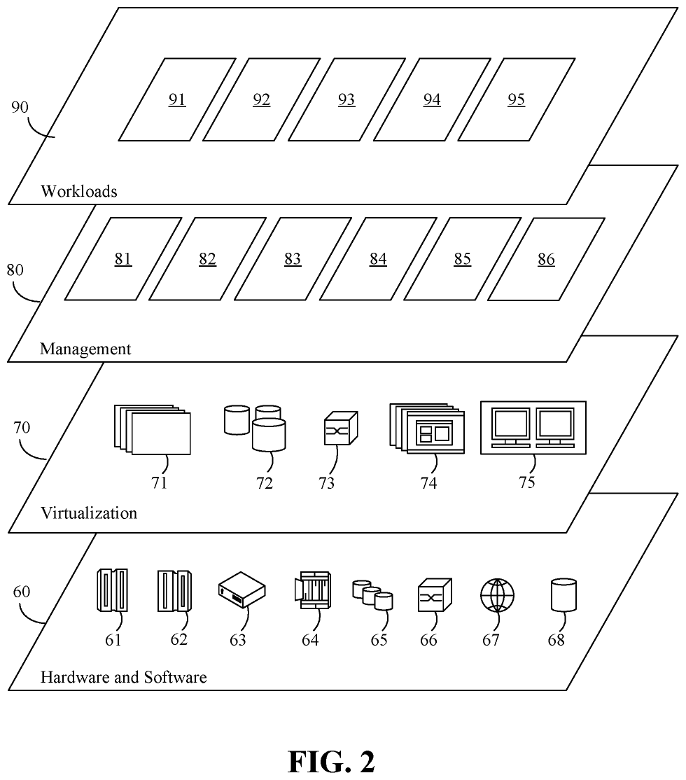

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components.

Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below.

Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA. Cloud service brokers 86 provide brokering of brokerage services to customers. The brokerage services utilize computing resources (and, optionally, other resources) of the cloud computing environment 50 to host workloads.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; and transaction processing 95.

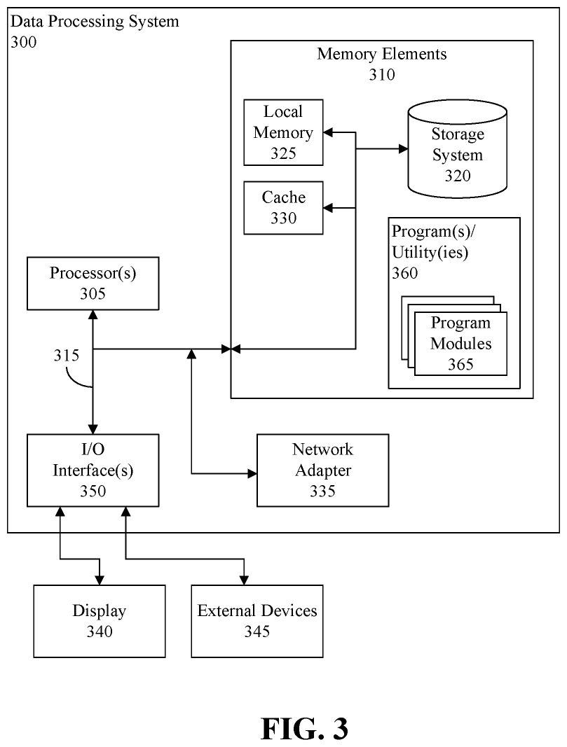

FIG. 3 is a block diagram illustrating example architecture for a data processing system 300. The data processing system 300 can be implemented at the hardware layer and software layer 60 of the cloud computing environment 50. The data processing system 300 can host one or more cloud service brokers 86 implemented at the management layer 80 of the cloud computing environment 50.

The data processing system 300 can include at least one processor 305 (e.g., a central processing unit) coupled to memory elements 310 through a system bus 315 or other suitable circuitry. As such, the data processing system 300 can store program code within the memory elements 310. The processor 305 can execute the program code accessed from the memory elements 310 via the system bus 315. It should be appreciated that the data processing system 300 can be implemented in the form of any system including a processor and memory that is capable of performing the functions and/or operations described within this specification. For example, the data processing system 300 can be implemented as a server, a plurality of communicatively linked servers, and so on.

The memory elements 310 can include a storage system 320, including one or more bulk storage devices, and local memory 325. Local memory 325 refers to random access memory (RAM) or other non-persistent memory device(s) generally used during actual execution of the program code. The bulk storage device(s) can be implemented as a hard disk drive (HDD), solid state drive (SSD), or other persistent data storage device. The data processing system 300 also can include one or more cache memories 330 that provide temporary storage of at least some program code in order to reduce the number of times program code must be retrieved from the bulk storage device(s) during execution.

One or more network adapters 335 also can be coupled to data processing system 300 to enable the data processing system 300 to become coupled to other systems, computer systems, remote printers, and/or remote storage devices through intervening private or public networks. Modems, cable modems, transceivers, and Ethernet cards are examples of different types of network adapters 335 that can be used with the data processing system 300.

Input/output (I/O) devices such as a display 340 and other external devices 345 can be coupled to the data processing system 300. The I/O devices can be coupled to the data processing system 300 either directly or through intervening I/O interface(s) 350. For example, the display 340 can be coupled to the data processing system 300 via a graphics processing unit (GPU), which may be a component of the processor 305 or a discrete device.

As pictured in FIG. 3, the memory elements 310 can store the components of the data processing system 300, namely one or more programs/utilities 360 including one or more program modules 365 that provide one or more cloud service brokers 86, for example executing on the virtualization layer 70 of the cloud computing environment 50. Being implemented in the form of executable program code, these components of the data processing system 300 can be executed by the data processing system 300 and, as such, can be considered part of the data processing system 300. Moreover, the program modules 365 are functional data structures that impart functionality when employed as part of the data processing system 300.

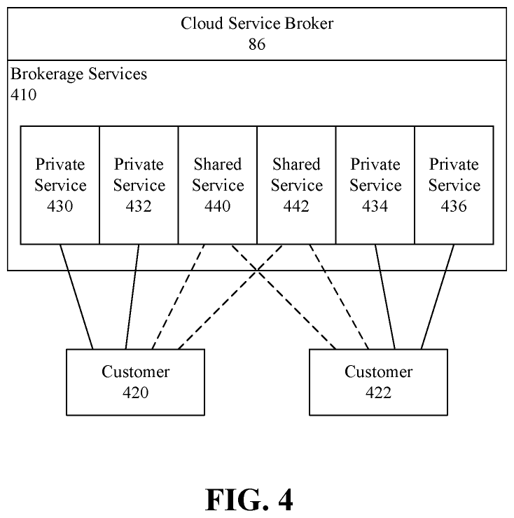

FIG. 4 depicts a cloud service broker 86 that provides brokerage services (hereinafter “services”) 410 according to an embodiment of the present invention. The cloud service broker 86 can broker a plurality of services 410 to a plurality of customers 420, 422. By way of example, the services 410 can be business process management services. The services 410 can include both private brokerage services (hereinafter “private services”) 430, 432, 434, 436 and shared brokerage services (hereinafter “shared services”) 440, 442. The cloud service broker 86 can provide each private service 430-436 to a single customer 420, 422, but provide each shared service 440, 442 to a plurality of customers 420, 422. In illustration, the cloud service broker 86 can provide the private services 430, 432 and shared services 440, 442 to the customer 420, and the cloud service broker 86 can provide the private services 434, 436 and shared services 440, 442 to the customer 422. Accordingly, each of the customers 420, 422 can utilize not only the shared services 440, 442, but also utilize the respective private services 430-436 that are exclusively allocated to them.

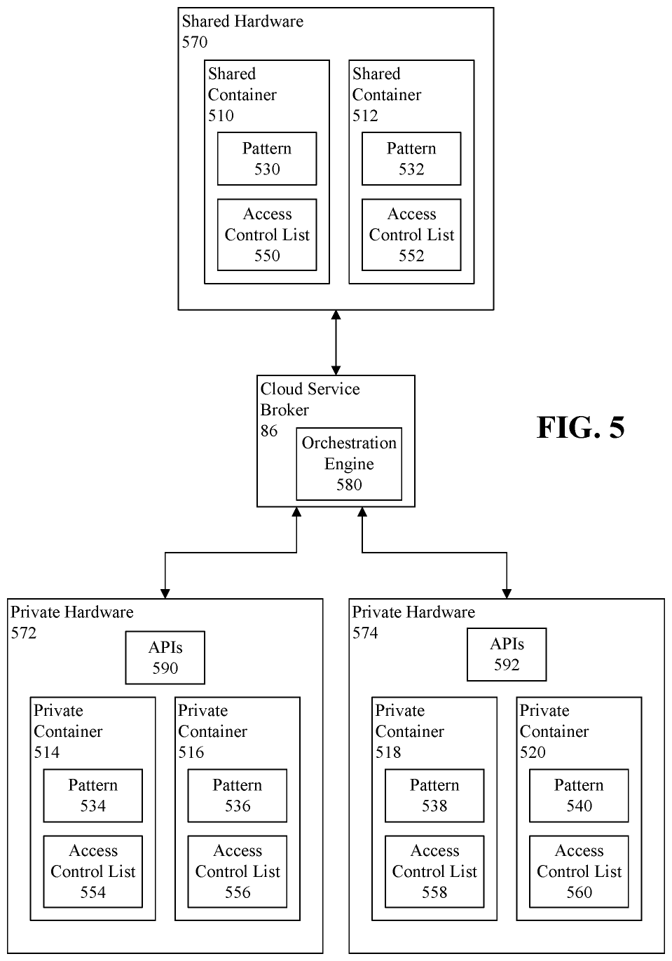

FIG. 5 depicts an implementation of a cloud service broker 86 according to an embodiment of the present invention. In this example, the various services 430-436 and 440-442 (FIG. 4) can be packaged into respective containers, 510, 512, 514, 516, 518, 520 as respective patterns 530, 532, 534, 536, 538, 540 using techniques known in the art. For instance, the shared service 440 can be packaged into a shared container 510 as a pattern 530, the shared service 442 can be packaged into a shared container 512 as a pattern 532, the private service 430 can be packaged into a private container 514 as a pattern 534, the private service 432 can be packaged into a private container 516 as a pattern 536, the private service 434 can be packaged into a private container 518 as a pattern 538, and the private service 436 can be packaged into a private container 520 as a pattern 540. Each container 510-520 can include a respective access control list 550, 552, 554, 556, 558, 560 which specifies which customers 420, 422 (FIG. 4) or other services/patterns can use the respective patterns 530-540, and thus the respective services 440, 442 and 430-436.

Although containers are discussed in the remainder of this document, the present arrangements are not limited in this regard. In illustration, one or more of the patterns 530, 532, 534, 536, 538, 540 can be hosted in virtual machines or hosted using microcode in lieu of being packaged into (a) container(s). For example, the patterns 530, 532 can be hosted in one or more virtual machines executing on one or more servers of the shared hardware 570 or the patterns 530, 532 can be hosted in microcode executing on a virtual local area network (VLAN) the shared hardware 570. Moreover, the patterns 534, 536 can be hosted in one or more virtual machines executing on one or more servers of the private hardware 572 or the patterns 534, 536 can be hosted in microcode executing on a VLAN of the private hardware 572. Similarly, the patterns 538, 540 can be hosted in one or more virtual machines executing on one or more servers of the private hardware 574 or the patterns 538, 540 can be hosted in microcode executing a VLAN of the private hardware 574. Those skilled in the art will understand how to host one or more of the patterns 530, 532, 534, 536, 538, 540 in containers, virtual machines or using microcode.

The shared containers 510, 512 can be hosted by shared hardware 570. For example, the shared containers 510, 512 can be stored to memory elements (e.g., a storage system, local memory and/or cache memory) used by one or more data processing systems (e.g., servers) of the shared hardware 570 and the patterns 530, 532 can be executed by the processor(s) of that/those data processing system(s). The cloud service broker 86 can execute on the data processing system(s) of shared hardware 570 or execute on one or more other data processing systems communicatively linked to the shared hardware 570 via one or more suitable communication networks.

The private containers 514, 516 can be hosted by private hardware 572, for example hardware owned by and/or managed by the customer 420 (FIG. 4). For example, the private containers 514, 516 can be stored to memory elements used by one or more data processing systems (e.g., servers) of the private hardware 572 and the patterns 534, 536 can be executed by the processor(s) of that/those data processing system(s). The private containers 518, 520 can be hosted by private hardware 574, for example hardware owned by and/or managed by the customer 422 (FIG. 4). For example, the private containers 518, 520 can be stored to memory elements used by one or more data processing systems (e.g., servers) of the private hardware 574 and the patterns 538, 540 can be executed by the processor(s) of that/those data processing system(s). By virtue of hosting the private containers 572, 574 that are accessed by the cloud service broker 86, as will be described herein, the private hardware 572, 574 are part of the cloud computing environment 50 (FIG. 1).

The cloud service broker 86 can include an orchestration engine 580 configured to orchestrate the flow of data between services. By way of example, as the patterns 530-540 execute, the services implemented by those patterns 530-540 may require that data be passed to and/or require that data be received from other patterns 530-540. The patterns 530-540 can interface with the orchestration engine 580 to pass corresponding requests. For example, the pattern 534 may require a sub-routine be performed by the pattern 530, and thus can pass a request to the orchestration engine 580 with data to be processed by the pattern 530. Similarly, the pattern 530 may require a sub-routine be performed by the pattern 536, and thus can pass a request to the orchestration engine 580 with data to be processed by the pattern 536.

During operation, processes performed for the customer 420 may rely on shared services 440, 442 packaged in the shared containers 510, 512 as patterns 530, 532 as well as private services 430, 432 packaged in the private containers 514, 516 as patterns 534, 536. Similarly, processes performed for the customer 422 may rely on shared services 440, 442 packaged in the shared containers 510, 512 as patterns 530, 532 as well as private services 434, 436 packaged in the private containers 518, 520 as patterns 538, 540. The private containers 514-520, however, may not be directly accessible by the orchestration engine 580. For example, the private containers 514-520 may be located behind firewalls. Rather than accessing the patterns 534-540 directly, the orchestration engine 580 can access the patterns 534-540 using application programming interface (API) calls. For example, the private hardware 572 can host one or more APIs 590, and the private hardware 574 can host one or more APIs 592. An API 590 can be assigned/dedicated to a single respective container 514, 516 and configured to operate for that container 514, 516 or assigned/dedicated to a plurality of containers 514, 516 and configured to operate for those containers 514, 516. Similarly, an API 592 can be assigned/dedicated to a single respective container 518, 520 and configured to operate for that container 518, 520, or assigned/dedicated to a plurality of containers 518, 520 and configured to operate for those containers 518, 520. Of course, appropriate ports in the respective firewalls can be open to enable the orchestration engine 580 to communicate with the APIs 590, 592.

The APIs 590, 592 can be constructed using any of a variety of techniques known in the art, for example using Simple Object Access Protocol (SOAP), based web services and service-oriented architecture (SOA), representational state transfer (REST) style web resources, resource-oriented architecture (ROA), etc. In illustration, REST APIs can be constructed so that they are loosely coupled, meaning the APIs can be configured to interface with other APIs and translate communications with the other APIs. REST API's typically utilize http transfer to pass eXtended Markup Language (XML) or JavaScript Object Notation (JSON) back and forth between a resources and entities accessing the resources via the REST APIs, which is known in the art.

The orchestration engine 580 can automatically request use of the patterns 534-540, in real time, using API calls to their respective APIs 590, 592 in lieu of uploading instances of the patterns 534-540 to the shared hardware 570 or to other hardware. Further, the private hardware 572 can apply security encryption to the patterns 534, 536 during execution of the patterns 534, 536, and the private hardware 574 can apply security encryption to the patterns 538, 540 during execution of the patterns 538, 540.

In an arrangement, the orchestration engine 580 can directly access the patterns 530, 532 in the shared containers 510, 512. In another arrangement, the shared hardware 570 also can host one or more APIs (not shown), and the orchestration engine 580 can request use of the patterns 532, 532 using API calls to their respective APIs.

By placing the patterns 534-540 in private containers 514-520 (or hosting the patterns 534-540 in virtual machines or using microcode) in private hardware 572, 574 accessible to the orchestration engine 580 using API calls rather than uploading instances of the patterns 534-540 to the shared hardware 570, the arrangements described herein provide a high level of security for the patterns 534-540, while also reducing workloads on the shared hardware 570, which improves performance of the shared hardware 570 at processing other workloads.

Notwithstanding, the patterns 530, 532 used by a plurality of customers 420, 422 can be hosted on shared hardware. Thus, computer program code for the patterns 530, 532 need not be duplicated among multiple customers 420, 422. Instead, new instances of the patterns 530, 532 that are shared can be instantiated when those patterns 530, 532 are to be used.

Further, the use of containers 514-520 (or virtual machines or microcode) facilitates migration of the patterns 534-540 to new private hardware, for example if a customer 420, 422 merges with another entity, is acquired by another entity, etc. In illustration, if the customers 420, 422 are companies, and customer 420 acquires customer 422, the private containers 518, 520 and APIs 592 can be moved from the private hardware 574 to the private hardware 572. The orchestration engine need only be updated with the new IP addresses of the private hardware 572 hosting the relocated private containers 518, 520 and APIs 592 in order to access the private containers 518, 520 at their new location. Various tools that may be used for migrating containers, virtual machines and microcode are known in the art.

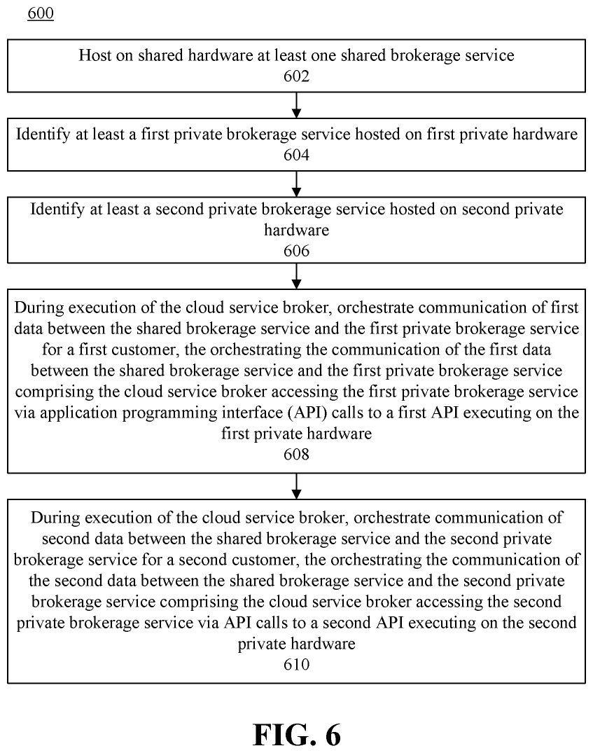

FIG. 6 is a flowchart illustrating an example of a method 600 of orchestrating communication of data between a shared brokerage service and private brokerage services. The method 600 can be implemented by the cloud service broker 86 of FIGS. 2, 4 and 5.

At step 602 the cloud service broker 86 can host on shared hardware at least one shared brokerage service. At step 604 the cloud service broker 86 can identify at least a first private brokerage service hosted on first private hardware. At step 606 the cloud service broker 86 can identify at least a second private brokerage service hosted on second private hardware.

At step 608 the cloud service broker 86 can, during execution of the cloud service broker, orchestrate communication of first data between the shared brokerage service and the first private brokerage service for a first customer, the orchestrating the communication of the first data between the shared brokerage service and the first private brokerage service comprising the cloud service broker accessing the first private brokerage service via application programming interface (API) calls to a first API executing on the first private hardware

At step 610 the cloud service broker 86 can, during execution of the cloud service broker, orchestrate communication of second data between the shared brokerage service and the second private brokerage service for a second customer, the orchestrating the communication of the second data between the shared brokerage service and the second private brokerage service comprising the cloud service broker accessing the second private brokerage service via API calls to a second API executing on the second private hardware.

The foregoing description is just an example of embodiments of the invention, and variations and substitutions. While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart(s) and block diagram(s) in the Figures illustrate the architecture, functionality, and operation of possible implementations of systems, methods, and computer program products according to various embodiments of the present invention. In this regard, each block in the flowchart(s) or block diagram(s) may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” “one arrangement,” “an arrangement,” “one aspect,” “an aspect,” or similar language means that a particular feature, structure, or characteristic described in connection with the embodiment is included in at least one embodiment described within this disclosure. Thus, appearances of the phrases “one embodiment,” “an embodiment,” “one arrangement,” “an arrangement,” “one aspect,” “an aspect,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
hosting on shared hardware at least one shared brokerage service;
identifying at least a first private brokerage service hosted on first private hardware;
identifying at least a second private brokerage service hosted on second private hardware;
during execution of a cloud service broker, the cloud service broker orchestrating, using a processor, communication of first data between the shared brokerage service and the first private brokerage service for a first customer, the orchestrating the communication of the first data between the shared brokerage service and the first private brokerage service comprising the cloud service broker accessing the first private brokerage service via application programming interface (API) calls to a first API executing on the first private hardware; and
during execution of the cloud service broker, the cloud service broker orchestrating communication of second data between the shared brokerage service and the second private brokerage service for a second customer, the orchestrating the communication of the second data between the shared brokerage service and the second private brokerage service comprising the cloud service broker accessing the second private brokerage service via API calls to a second API executing on the second private hardware.

2. The method of claim 1, wherein the first private brokerage service is packaged as a first pattern and the second private brokerage service is packaged as a second pattern.

3. The method of claim 2, wherein the first pattern is contained in a first private container hosted on the first private hardware and the second pattern is contained in a second private container hosted on the second private hardware.

4. The method of claim 2, wherein the first pattern is hosted in a first virtual machine executing on the first private hardware and the second pattern is hosted in a second virtual machine executing on the second private hardware.

5. The method of claim 2, wherein the first pattern is hosted in first microcode on a first virtual private network of the first private hardware and the second pattern is hosted in second microcode on a first virtual private network of the second private hardware.

6. The method of claim 2, wherein the first pattern is contained in a private container hosted on the first private hardware and the second pattern is hosted in a virtual machine executing on the second private hardware.

7. The method of claim 2, wherein the first private hardware applies security encryption to the first pattern during execution of the first pattern and the second private hardware applies security encryption to the second pattern during execution of the second pattern.

8. A system, comprising:
a processor programmed to initiate executable operations comprising:
hosting on shared hardware at least one shared brokerage service;
identifying at least a first private brokerage service hosted on first private hardware;
identifying at least a second private brokerage service hosted on second private hardware;
during execution of a cloud service broker, the cloud service broker orchestrating communication of first data between the shared brokerage service and the first private brokerage service for a first customer, the orchestrating the communication of the first data between the shared brokerage service and the first private brokerage service comprising the cloud service broker accessing the first private brokerage service via application programming interface (API) calls to a first API executing on the first private hardware; and
during execution of the cloud service broker, the cloud service broker orchestrating communication of second data between the shared brokerage service and the second private brokerage service for a second customer, the orchestrating the communication of the second data between the shared brokerage service and the second private brokerage service comprising the cloud service broker accessing the second private brokerage service via API calls to a second API executing on the second private hardware.

9. The system of claim 8, wherein the first private brokerage service is packaged as a first pattern and the second private brokerage service is packaged as a second pattern.

10. The system of claim 9, wherein the first pattern is contained in a first private container hosted on the first private hardware and the second pattern is contained in a second private container hosted on the second private hardware.

11. The system of claim 9, wherein the first pattern is hosted in a first virtual machine executing on the first private hardware and the second pattern is hosted in a second virtual machine executing on the second private hardware.

12. The system of claim 9, wherein the first pattern is hosted in first microcode on a first virtual private network of the first private hardware and the second pattern is hosted in second microcode on a first virtual private network of the second private hardware.

13. The system of claim 9, wherein the first pattern is contained in a private container hosted on the first private hardware and the second pattern is hosted in a virtual machine executing on the second private hardware.

14. The system of claim 9, wherein the first private hardware applies security encryption to the first pattern during execution of the first pattern and the second private hardware applies security encryption to the second pattern during execution of the second pattern.

15. A computer program product, comprising:
a computer readable storage medium having program code stored thereon, the program code executable by a data processing system to initiate operations including:
hosting on shared hardware at least one shared brokerage service;
identifying at least a first private brokerage service hosted on first private hardware;
identifying at least a second private brokerage service hosted on second private hardware;
during execution of a cloud service broker, the cloud service broker orchestrating communication of first data between the shared brokerage service and the first private brokerage service for a first customer, the orchestrating the communication of the first data between the shared brokerage service and the first private brokerage service comprising the cloud service broker accessing the first private brokerage service via application programming interface (API) calls to a first API executing on the first private hardware; and
during execution of the cloud service broker, the cloud service broker orchestrating communication of second data between the shared brokerage service and the second private brokerage service for a second customer, the orchestrating the communication of the second data between the shared brokerage service and the second private brokerage service comprising the cloud service broker accessing the second private brokerage service via API calls to a second API executing on the second private hardware.

16. The computer program product of claim 15, wherein the first private brokerage service is packaged as a first pattern and the second private brokerage service is packaged as a second pattern.

17. The computer program product of claim 16, wherein the first pattern is contained in a first private container hosted on the first private hardware and the second pattern is contained in a second private container hosted on the second private hardware.

18. The computer program product of claim 16, wherein the first pattern is hosted in a first virtual machine executing on the first private hardware and the second pattern is hosted in a second virtual machine executing on the second private hardware.

19. The computer program product of claim 16, wherein the first pattern is hosted in first microcode on a first virtual private network of the first private hardware and the second pattern is hosted in second microcode on a first virtual private network of the second private hardware.

20. The computer program product of claim 16, wherein the first pattern is contained in a private container hosted on the first private hardware and the second pattern is hosted in a virtual machine executing on the second private hardware.
